(19) United States
(12) Patent Application Publication
(10) Pub. No.: US 2025/0251251 A1
(43) Pub. Date: Aug. 7, 2025

(54) EDGE-ASSISTED PERSONALIZED HIGH-DEFINITION MAP DELIVERY BASED ON DRIVERS’ INTERESTS

(71) Applicant: Toyota Motor Engineering & Manufacturing North America, Inc., Plano, TX (US)

(72) Inventors: Dawei Chen, Milpitas, CA (US); Qi Chen, San Jose, CA (US); Rohit Gupta, Santa Clara, CA (US); Kyungtae Han, Palo Alto, CA (US)

(73) Assignees: Toyota Motor Engineering & Manufacturing North America, Inc., Plano, TX (US); Toyota Jidosha Kabushiki Kaisha, Aichi-ken (JP)

(21) Appl. No.: 18/432,307

(22) Filed: Feb. 5, 2024

(51) Int. Cl. G01C 21/34; G01C 21/00; G01C 21/36

(52) U.S. Cl. CPC G01C 21/3476; G01C 21/3617; G01C 21/3878; G01C 21/3896

(57) ABSTRACT

A method may include receiving, from a vehicle, a request for a map of a geographic location, a driving application associated with the request, a position of the vehicle, and a direction that an occupant of the vehicle is looking. The method may further include determining information to be included in the map based on the driving application, generating the map that includes the information, determining an area of interest of the vehicle occupant based on the position of the vehicle and the direction that the occupant of the vehicle is looking, generating a recommendation based on the area of interest, and transmitting the generated map and the recommendation to the vehicle.

### TECHNICAL FIELD

The present specification relates to providing maps for autonomous vehicles, and more particularly, to edge-assisted personalized high-definition map delivery based on drivers' interests.

### BACKGROUND

Autonomous and semi-autonomous vehicles often rely on high-definition (HD) maps to perform navigation and other autonomous or semi-autonomous driving functions. HD maps may include various information such as traffic information, road closures, locations of debris, and the like. HD maps may have high resolution and may be frequently updated to dynamically add new information as road conditions change. As autonomous and semi-autonomous vehicles drive along different roads and through different geographic areas, new HD maps may be received from edge servers or other remote computing devices covering these areas.

However, HD maps covering a large area may comprise a large amount of data. As such, receiving such HD maps may use a large amount of bandwidth of vehicles. However, depending on the driving application for which an HD map is to be used, all of the information in an HD map may not be needed by a vehicle. Furthermore, a driver of a vehicle may have certain interests that can be enhanced by including certain information in an HD map transmitted to a vehicle. Therefore, a need exists for personalized HD maps to be delivered to autonomous or semi-autonomous vehicles.

### SUMMARY

In an embodiment, a method may include receiving, from a vehicle, a request for a map of a geographic location, a driving application associated with the request, a position of the vehicle, and a direction that an occupant of the vehicle is looking. The method may further include determining information to be included in the map based on the driving application, generating the map that includes the information, determining an area of interest of the vehicle occupant based on the position of the vehicle and the direction that the occupant of the vehicle is looking, generating a recommendation based on the area of interest, and transmitting the generated map and the recommendation to the vehicle.

In another embodiment, a computing device may comprise one or more processors. The one or more processors may receive, form a vehicle, a request for a map of a geographic location, a driving application associated with the request, a position of the vehicle, and a direction that an occupant of the vehicle is looking, determine information to be included in the map based on the driving application, generate the map that includes the information, determine an area of interest of the vehicle occupant based on the position of the vehicle and the direction that the occupant of the vehicle is looking, generate a recommendation based on the area of interest, and transmit the generated map and the recommendation to the vehicle.

In another embodiment, a system may include a vehicle and an edge server. The vehicle may transmit, to the edge server, a request for a map of a geographic location, a driving application associated with the request, a position of the vehicle, and a direction that an occupant of the vehicle is looking. The edge server may comprise one or more processors configured to receive the request from the vehicle, determine information to be included in the map based on the driving application, generate the map that includes the information, determine an area of interest of the vehicle occupant based on the position of the vehicle and the direction that the occupant of the vehicle is looking, generate a recommendation based on the area of interest, and transmit the generated map and the recommendation to the vehicle.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 schematically depicts a system for performing edge-assisted personalized high-definition map delivery based on drivers' interests, according to one or more embodiments shown and described herein;

FIG. 2 schematically depicts a vehicle system, according to one or more embodiments shown and described herein;

FIG. 3 schematically depicts memory modules of the vehicle system of FIG. 2, according to one or more embodiments shown and described herein;

FIG. 4 schematically depicts an edge server, according to one or more embodiments shown and described herein;

FIG. 5A schematically depicts a permanent static layer of an HD map, according to one or more embodiments shown and described herein;

FIG. 5B schematically depicts a transient static layer of an HD map, according to one or more embodiments shown and described herein;

FIG. 5C schematically depicts a transient dynamic layer of an HD map, according to one or more embodiments shown and described herein;

FIG. 5D schematically depicts a highly dynamic layer of an HD map, according to one or more embodiments shown and described herein;

FIG. 6 depicts a flowchart of a method that may be performed by the vehicle system of FIG. 2, according to one or more embodiments shown and described herein; and

FIG. 7 depicts a flowchart of a method that may be performed by the edge server of FIG. 4, according to one or more embodiments shown and described herein.

### DETAILED DESCRIPTION

The embodiments disclosed herein include a method and system for edge-assisted personalized high-definition map delivery based on drivers' interests. As an autonomous or semi-autonomous vehicle drives along a road, a vehicle system of the vehicle may request one or more HD maps from an edge server or other remote computing device to be used for one or more driving applications. The vehicle system may also include an internal camera that monitors the head position and eye gaze direction of the driver to determine in which direction the driver is looking.

The vehicle system may transmit the HD map request to the edge server along with the application for which the HD map is to be used, the location of the vehicle, the head position and eye gaze direction of the driver, and driving statistics. The edge server may analyze the received information and determine the type of information to include in an HD map to be transmitted back to the vehicle. The information to include in the HD map may be based on the driving application for which it is to be used. The edge server may also identify personalized recommendations that may be of interest to the driver based on the received information.

If any information to be included in the HD map is not stored locally on the edge server, the edge server may retrieve the needed information from the appropriate location. The edge server may then generate the HD map and transmit the generated HD map along with personalized recommendations to the vehicle. The vehicle may then utilize the received HD map to perform autonomous or semi-autonomous driving operations. The vehicle system may also display personalized information to the driver.

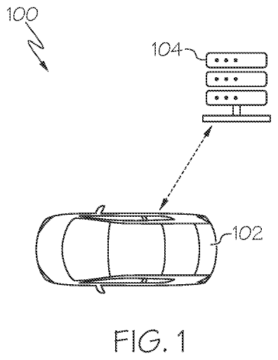

Turning now to the figures, FIG. 1 schematically depicts a system for personalized HD map delivery, as disclosed herein. In the example of FIG. 1, a system 100 includes a vehicle 102 and an edge server 104.

In the example of FIG. 1, the vehicle 102 is a connected vehicle. A connected vehicle is able to communicate remotely with systems outside of the vehicle (e.g., with the edge server 104). In the example of FIG. 1, the edge server 104 may be communicatively coupled to the vehicle 102.

In the example of FIG. 1, the vehicle 102 may be an autonomous or semi-autonomous vehicle. That is, the vehicle 102 may autonomously perform some or all driving tasks without intervention by the driver. As such, the vehicle 102 may perform a number of computational tasks in support of autonomous or semi-autonomous driving, such as navigation, trajectory planning, vehicle tracking, lane changing, object identification, object classification, and the like. The vehicle 102 may include an actuator for driving the vehicle, such as a motor, an engine, or any other powertrain. In order to perform such driving tasks, the vehicle 102 may request one or more HD maps from the edge server 104.

In embodiments, the vehicle 102 may request HD maps for different driving applications. For example, the vehicle 102 may request an HD map for navigation, braking assistance, lane changing, and the like. Different applications may need different types of information in an HD map. As such, the edge server 104 may determine the information to include in an HD map to be transmitted to the vehicle 102, as disclosed herein. The vehicle 102 may also monitor the direction that a driver or other passengers of the vehicle 102 are looking in order to determine their area of interest, as disclosed herein. The edge server 104 may transmit personalized recommendations to the vehicle 102 based on this area of interest, as disclosed in further detail below.

In the example of FIG. 1, the edge server 104 may comprise a computing device located near a road along which the vehicle 102 travels. The vehicle 102 may be communicatively coupled to the edge server 104 such that the vehicle 102 and the edge server 104 may transmit data between each other. A plurality of edge servers may be located at various locations along one or more roads such that the vehicle 102 may be in range of different edge servers at different times as it drives along the one or more roads. As discussed above, the edge server 104 may receive a request for an HD map from the vehicle 102. The edge server 104 may determine what information to include in the HD map, as discussed in further detail below.

The edge server 104 may maintain a static and/or dynamic map of the geographic area in which it is located. In particular, the edge server 104 may store static information (e.g., arrangements of roads and traffic infrastructure) and dynamic information (e.g., temporary road closures and locations of vehicles). The edge server 104 may update dynamic information by receiving real-time data from connected vehicles and/or other data providers. As such, the edge server 104 may be able to generate an HD map of the geographic area in which it is located, as disclosed herein.

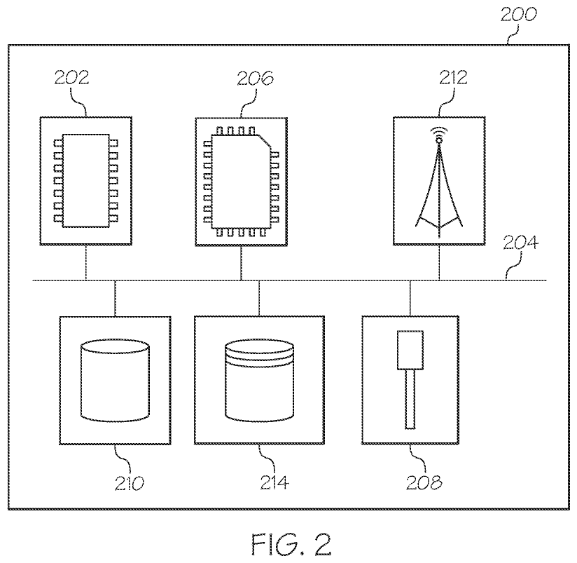

FIG. 2 depicts an example vehicle system 200 that may be included in the vehicle 102 of FIG. 1. In the example of FIG. 2, the vehicle system 200 includes one or more processors 202, a communication path 204, one or more memory modules 206, a satellite antenna 208, one or more vehicle sensors 210, a network interface hardware 212, and a data storage component 214, the details of which will be set forth in the following paragraphs.

Each of the one or more processors 202 may be any device capable of executing machine readable and executable instructions. Accordingly, each of the one or more processors 202 may be a controller, an integrated circuit, a microchip, a computer, or any other computing device. The one or more processors 202 are coupled to a communication path 204 that provides signal interconnectivity between various modules of the vehicle system 200. Accordingly, the communication path 204 may communicatively couple any number of processors 202 with one another, and allow the modules coupled to the communication path 204 to operate in a distributed computing environment. Specifically, each of the modules may operate as a node that may send and/or receive data. As used herein, the term “communicatively coupled” means that coupled components are capable of exchanging data signals with one another such as, for example, electrical signals via conductive medium, electromagnetic signals via air, optical signals via optical waveguides, and the like.

Accordingly, the communication path 204 may be formed from any medium that is capable of transmitting a signal such as, for example, conductive wires, conductive traces, optical waveguides, or the like. In some embodiments, the communication path 204 may facilitate the transmission of wireless signals, such as Wi-Fi, Bluetooth®, Near Field Communication (NFC) and the like. Moreover, the communication path 204 may be formed from a combination of mediums capable of transmitting signals. In one embodiment, the communication path 204 comprises a combination of conductive traces, conductive wires, connectors, and buses that cooperate to permit the transmission of electrical data signals to components such as processors, memories, sensors, input devices, output devices, and communication devices. Accordingly, the communication path 204 may comprise a vehicle bus, such as for example a LIN bus, a CAN bus, a VAN bus, and the like. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium.

The vehicle system 200 includes one or more memory modules 206 coupled to the communication path 204. The one or more memory modules 206 may comprise RAM, ROM, flash memories, hard drives, or any device capable of storing machine readable and executable instructions such that the machine readable and executable instructions can be accessed by the one or more processors 202. The machine readable and executable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable and executable instructions and stored on the one or more memory modules 206. Alternatively, the machine readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components.

Referring still to FIG. 2, the vehicle system 200 comprises a satellite antenna 208 coupled to the communication path 204 such that the communication path 204 communicatively couples the satellite antenna 208 to other modules of the vehicle system 200. The satellite antenna 208 is configured to receive signals from global positioning system satellites. Specifically, in one embodiment, the satellite antenna 208 includes one or more conductive elements that interact with electromagnetic signals transmitted by global positioning system satellites. The received signal is transformed into a data signal indicative of the location (e.g., latitude and longitude) of the satellite antenna 208, and consequently, the vehicle containing the vehicle system 200.

The vehicle system 200 comprises one or more vehicle sensors 210. Each of the one or more vehicle sensors 210 is coupled to the communication path 204 and communicatively coupled to the one or more processors 202. The one or more vehicle sensors 210 may include, but are not limited to, LiDAR sensors, RADAR sensors, optical sensors (e.g., cameras, laser sensors), proximity sensors, location sensors (e.g., GPS modules), and the like. The vehicle sensors 210 may collect data that may be used to autonomously drive the vehicle. The vehicle sensors 210 may also collect driving statistics, such as how long the vehicle 102 has been driving.

In embodiments, the vehicle sensors 210 also include an internal camera that monitors the driver of the vehicle 102. In particular, the internal camera may monitor the head position and eye gaze direction of the driver. This information may be used to determine the direction that the driver is looking, which may indicate what the driver's attention is focused on, as disclosed in further detail below.

Still referring to FIG. 2, the vehicle system 200 comprises network interface hardware 212 for communicatively coupling the vehicle system 200 to the edge server 104. The network interface hardware 212 can be communicatively coupled to the communication path 204 and can be any device capable of transmitting and/or receiving data via a network. Accordingly, the network interface hardware 212 can include a communication transceiver for sending and/or receiving any wired or wireless communication. For example, the network interface hardware 212 may include an antenna, a modem, LAN port, Wi-Fi card, WiMax card, mobile communications hardware, near-field communication hardware, satellite communication hardware and/or any wired or wireless hardware for communicating with other networks and/or devices.

Still referring to FIG. 2, the vehicle system 200 comprises a data storage component 214. The data storage component 214 may store data used by various components of the vehicle system 200. In addition, the data storage component 214 may store data collected by the vehicle sensors 210 and data received from the edge server 104.

In some embodiments, the vehicle system 200 may be communicatively coupled to the edge server 104 by a network. In one embodiment, the network may include one or more computer networks (e.g., a personal area network, a local area network, or a wide area network), cellular networks, satellite networks and/or a global positioning system and combinations thereof. Accordingly, the vehicle system 200 can be communicatively coupled to the network via a wide area network, via a local area network, via a personal area network, via a cellular network, via a satellite network, etc. Suitable local area networks may include wired Ethernet and/or wireless technologies such as, for example, Wi-Fi. Suitable personal area networks may include wireless technologies such as, for example, IrDA, Bluetooth®, Wireless USB, Z-Wave, ZigBee, and/or other near field communication protocols. Suitable cellular networks include, but are not limited to, technologies such as LTE, WiMAX, UMTS, CDMA, and GSM.

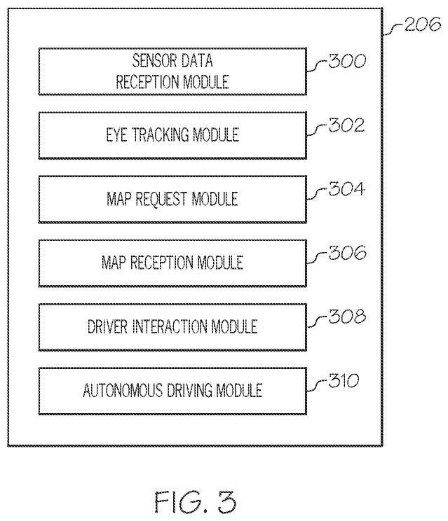

Now referring to FIG. 3, the memory modules 206 of the vehicle system 200 are schematically shown. The one or more memory modules 206 include a sensor data reception module 300, an eye tracking module 302, a map request module 304, a map reception module 306, a driver interaction module 308, and an autonomous driving module 310. Each of the sensor data reception module 300, the eye tracking module 302, the map request module 304, the map reception module 306, the driver interaction module 308, and the autonomous driving module 310 may be a program module in the form of operating systems, application program modules, and other program modules stored in the one or more memory modules 206. In some embodiments, the program module may be stored in a remote storage device that may communicate with the vehicle system 200. Such a program module may include, but is not limited to, routines, subroutines, programs, objects, components, data structures and the like for performing specific tasks or executing specific data types as will be described below.

The sensor data reception module 300 may receive data from the vehicle sensors 210. In particular, the sensor data reception module 300 may receive information about the state of the vehicle 102 and the surrounding environment. The sensor data reception module 300 may receive Lidar data, Radar data, or other data capturing information about the environment around the vehicle 102, which the vehicle 102 may use to perform autonomous or semi-autonomous driving. For example, the sensor data reception module 300 may capture positions of vehicles and other road agents on the road, positions and states of traffic infrastructure (e.g., stop signs, stop lights), and other data that may be used to perform autonomous or semi-autonomous driving.

The sensor data reception module 300 may also receive data about the state of the vehicle 102. This may include a position of the vehicle 102, a speed of the vehicle 102, an acceleration of the vehicle 102, and an amount of time that the vehicle 102 has been driving. The sensor data reception module 300 may also capture eye tracking data of a driver of the vehicle 102. In particular, an internal camera may capture video and/or still images of a person in the driver's seat of the vehicle 102 (e.g., images of the driver's head and eyes). This video or image data may indicate a head position and/or eye gaze direction of the driver, and may be used by the eye tracking module 302, as discussed in further detail below. In some examples, the sensor data reception module 300 may capture eye tracking data of other passengers in the vehicle 102.

The eye tracking module 302 may determine a direction that the driver or other passengers in the vehicle 102 are looking, as disclosed herein. As discussed above, the sensor data reception module 300 may receive video and/or image data of the driver of the vehicle 102. This may specifically include images of the driver's head and eyes. As such, the eye tracking module 302 may determine a position of the driver's head and a direction that the driver's eyes are looking based on the received video and/or image data. In particular, the eye tracking module 302 may determine a direction that the driver's eyes are looking with respect to the vehicle 102. For example, the eye tracking module 302 may determine angles from one or more axes with respect to the vehicle 102 that the driver is looking. This may be used by the edge server 104 determine what the driver is looking at, as disclosed in further detail below.

In embodiments, the sensor data reception module 300 may continually capture video and/or image data of the driver of the vehicle 102 at particular intervals of time (e.g., every second), and the eye tracking module 302 may determine a direction that the driver of the vehicle 102 is looking at particular intervals of time (e.g., every second). In some examples, the eye tracking module 302 may determine a direction that other passengers of the vehicle 102 are looking based on data captured by the sensor data reception module 300 (e.g., video and/or images of the head and eyes of other passengers).

The map request module 304 may request an HD map from the edge server 104, as disclosed herein. As discussed above, in order to perform certain autonomous or semi-autonomous driving functions, the vehicle 102 may utilize an HD map of a particular geographic location. However, storing all possible maps that the vehicle 102 may need locally would require a large amount of data storage. Accordingly, in order to reduce the data storage needed, the vehicle 102 may request HD maps from the edge server 104 as they are needed. As such, as the vehicle 102 travels through different geographic areas, the vehicle 102 may request an HD map of each geographic area it travels through, store it locally while the vehicle is in that geographic area, and then delete the map when the vehicle 102 leaves the area and the map is no longer needed. This may allow the vehicle 102 to access HD maps as needed for performing autonomous or semi-autonomous driving functions while minimizing the amount of data storage needed to locally store HD maps.

In embodiments, when the vehicle 102 is positioned in or heading towards a particular geographic area, the map request module 304 may transmit a request for an HD map of the geographic area to the edge server 104. In particular, the map request module 304 may transmit a request for an HD map to the edge server 104 when such a map is needed for performing a particular autonomous or semi-autonomous driving function. For example, if the vehicle 102 is planning a navigation route, the vehicle 102 may request a map of the geographic area to be traversed to plan the navigation route. In another example, if the vehicle 102 is planning a lane change maneuver, the vehicle 102 may request a map to identify an arrangement of lanes to plan the lane change maneuver. In other examples, an HD map may be utilized to perform other driving applications.

In embodiments, the map request module 304 may transmit, to the edge server 104, a request for an HD map of a particular geographic area. The map request module 304 may also transmit driving statistics for the vehicle 102, the location of the vehicle 102 and information about the direction the driver of the vehicle is looking. The map request module 304 may also transmit the driving application for which the HD map is to be used (e.g., navigation, lane changing). The edge server 104 may utilize this information to determine recommendations, as disclosed herein.

The map reception module 306 may receive an HD map from the edge server 104. In particular, the map reception module 306 may receive an HD map from the edge server 104 in response to a request transmitted by the map request module 304. The HD map received by the map reception module 306 may include different types of information depending on the driving application the map is to be used for, as discussed in further detail below. The map reception module 306 may also receive recommendation information from the edge server 104, as disclosed herein. In particular, the map reception module 306 may receive recommendation information based on an area of interest being viewed by the driver and/or driving statistics, as discussed in further detail below.

For example, if the driver of the vehicle 102 is looking at a restaurant, the edge server 104 may transmit information about the restaurant such as menu, rating, etc. If the driver of the vehicle 102 is looking at a hotel, the edge server 104 may transmit information about the hotel. If the driver of the vehicle 102 is looking at a road-side advertisement, the edge server 104 may transmit information about the product or business being advertised. If the driver of the vehicle is looking at a parking lot, the edge server 104 may transmit information about the number of available parking spots. In addition to transmitting information about whatever the driver of the vehicle 102 is looking at, the edge server 104 may also transmit digital coupons or offers for deals with the business or entity being looked at. This various recommendation information may be received by the map reception module 306. In some embodiments, the recommendation information may be already embedded in the HD map sent from the edge server 104. That is, the edge server 104 augmented the HD map with the recommendation information and sent the augmented HD map to the map reception module 306.

The driver interaction module 308 may use the recommendation information received by the map reception module 306 to interact with the driver of the vehicle 102, as disclosed herein. As discussed above, the map reception module 306 may receive, from the edge server 104, recommendation information about a business or entity that the driver of the vehicle 102 is looking at. After receiving the recommendation information, the driver interaction module 308 may display the recommendation information to the driver. For example, the driver interaction module 308 may cause the recommendation information to be displayed on a display screen in the vehicle 102.

In some examples, the driver interaction module 308 may allow the driver of the vehicle 102 to interact with the recommendation information. For example, the driver interaction module 308 may cause the recommendation information to be displayed on a touch screen in the vehicle 102, which the driver can interact with. For example, if the recommendation information includes a digital coupon or other offer from a particular business, the driver may touch the offer on the touch screen in order to accept the offer. In some examples, the driver may be able to like or dislike a recommendation being shown. In some examples, the driver interaction module 308 may cause the touch screen to display different options for the driver with respect to a particular business. For example, the driver interaction module 308 may allow the driver to make a reservation at a restaurant, secure a reservation at a hotel, or call a business directly. In some examples, the driver interaction module 308 may allow the driver to update the route of the vehicle to include stopping at a selected business. The driver interaction module 308 may monitor the interaction with the driver (e.g., determining which options the driver selects) and take appropriate action (e.g., transmitting a message to secure a reservation).

In some examples, after the driver interacts with a particular recommendation, the driver interaction module 308 may transmit information about the interaction to the edge server 104. For example, if the driver likes or dislikes a particular recommendation, the driver interaction module 308 may transmit this information to the edge server 104. The edge server 104 may use this information as feedback to revise future recommendations. For example, the edge server 104 may make more future recommendations similar to business that the driver liked and less future recommendations similar to businesses that the driver disliked.

The autonomous driving module 310 may cause the vehicle 102 perform autonomous or semi-autonomous driving actions. In particular, the autonomous driving module 310 may utilize information in an HD map received by the map reception module 306 to perform one or more autonomous or semi-autonomous driving operations.

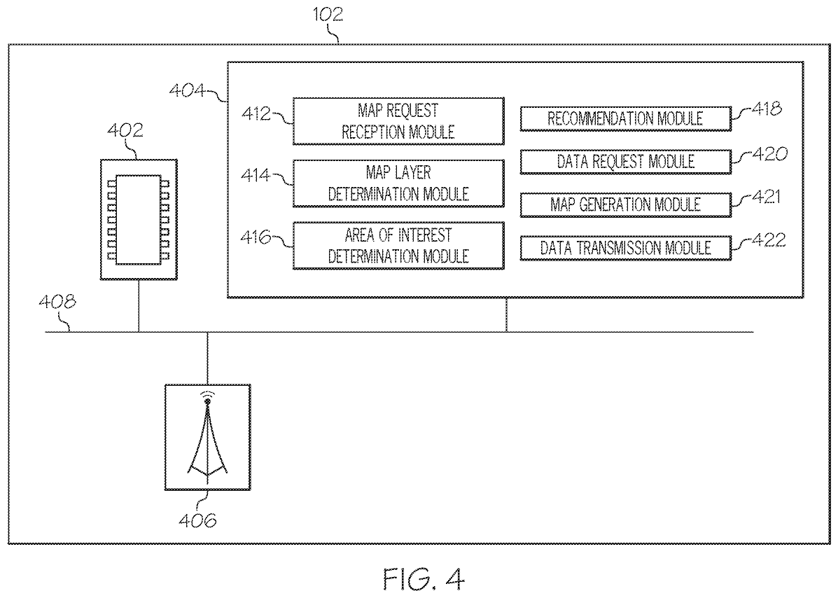

Now referring to FIG. 4, the edge server 104 comprises one or more processors 402, one or more memory modules 404, network interface hardware 406, and a communication path 408. The one or more processors 402 may be a controller, an integrated circuit, a microchip, a computer, or any other computing device. The one or more memory modules 404 may comprise RAM, ROM, flash memories, hard drives, or any device capable of storing machine readable and executable instructions such that the machine readable and executable instructions can be accessed by the one or more processors 402.

The network interface hardware 406 can be communicatively coupled to the communication path 408 and can be any device capable of transmitting and/or receiving data via a network. Accordingly, the network interface hardware 406 can include a communication transceiver for sending and/or receiving any wired or wireless communication. For example, the network interface hardware 406 may include an antenna, a modem, LAN port, Wi-Fi card, WiMax card, mobile communications hardware, near-field communication hardware, satellite communication hardware and/or any wired or wireless hardware for communicating with other networks and/or devices. The network interface hardware 406 of the edge server 104 may transmit and receive data to and from the vehicle 102.

The one or more memory modules 404 include a map request reception module 412, a map layer determination module 414, an area of interest determination module 416, a recommendation module 418, a data request module 420, a map generation module 421, and a data transmission module 422. Each of the map request reception module 412, the map layer determination module 414, the area of interest determination module 416, the recommendation module 418, the data request module 420, the map generation module 421, and the data transmission module 422 may be a program module in the form of operating systems, application program modules, and other program modules stored in the one or more memory modules 404. Such a program module may include, but is not limited to, routines, subroutines, programs, objects, components, data structures and the like for performing specific tasks or executing specific data types as will be described below.

The map request reception module 412 may receive a request for an HD map from the vehicle 102. As discussed above, the request may identify a particular geographic area for which an HD map is desired by the vehicle 102. The request may also include the driving application for which the HD map is to be used, vehicle statistics associated with the vehicle 102 (e.g., how long the vehicle 102 has been driving), the location of the vehicle 102, and eye tracking data for the driver of the vehicle 102. The edge server 104 may utilize the information included in the request received by the map request reception module 412 to identify a map to transmit to the vehicle 102 as well as recommendations for the driver of the vehicle 102, as disclosed herein.

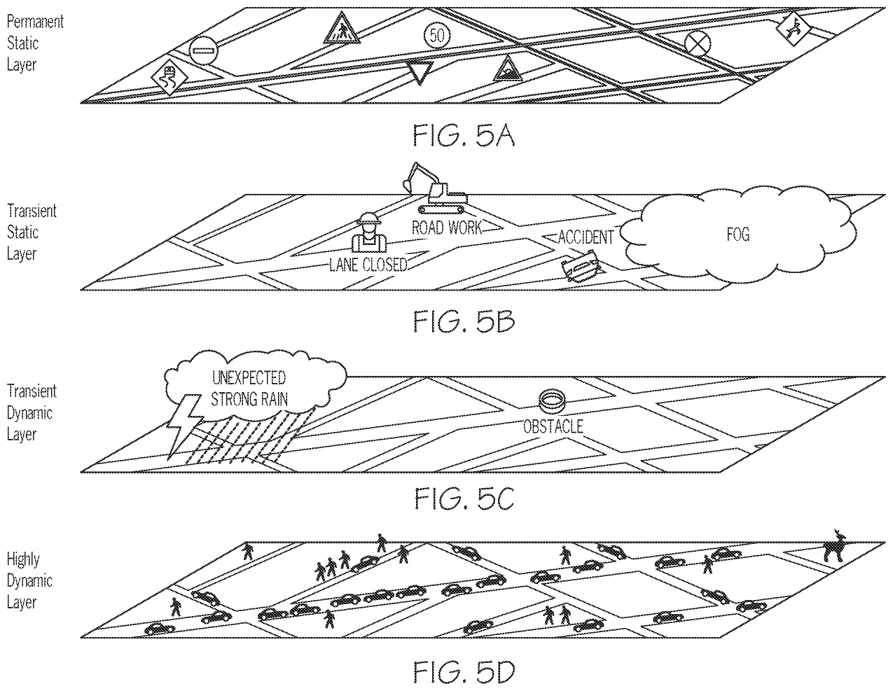

The map layer determination module 414 may determine one or more map layers to include in the HD map to be transmitted to the vehicle 102. An HD map may be overlaid with various information, such as traffic information, road closures, and locations of road debris, as discussed above. In particular, an HD map may include different layers containing different types of information. FIGS. 5A-5D show different layers of information that may be included in an HD map.

FIG. 5A shows a permanent static layer. The permanent static layer of FIG. 5A may include features that are static and do not change over time. For example, the permanent static layer may include roads and road signs.

FIG. 5B shows a transient static layer. The transient static layer of FIG. 5B may include features that are static, in that they do not vary once they are static, but transient, in that they may appear and disappear at different times. For example, the transient static layer may include information about road closures, construction, accidents, and fog.

FIG. 5C shows a transient dynamic layer. The transient dynamic layer of FIG. 5C may include features that are both transient, in that they may appear and disappear at different times, and also dynamic, in that they may change while they are present. For example, the transient dynamic layer may include weather information and obstacles on the road.

FIG. 5D shows a highly dynamic layer. The highly dynamic layer of FIG. 5D may include features that are constantly changing. For example, the transient dynamic layer may include positions of other vehicles and pedestrians.

Depending on the type of driving application for which an HD map is requested, different layers or different types of information may be needed. For example, if an HD map is to be used for navigation, an HD map may only need to include the permanent static layer and the transient static layer. However, if an HD map is to be used for braking assistance or lane changing, the highly dynamic layer may be needed. Accordingly, the map layer determination module 414 may determine what information to include in an HD map based on the particular driving application for which the HD map is to be used.

In some examples, the map layer determination module 414 may utilize a look-up table to determine what information to include in an HD map based on driving application. For example, the edge server 104 may store a look-up table with a plurality of driving applications and one or more associated layers for each such application. As such, when the edge server 104 receives a request for an HD map, the map layer determination module 414 may access the look-up table and identify the layers to be included in an HD map for the specified driving application. For example, the look-up table may indicate that an HD map for navigation should include the permanent static layer and the transient layer, and that an HD map for lane changing should include the highly dynamic layer.

In other examples, the map layer determination module 414 may utilize techniques other than a look-up table to determine what information to include in an HD map. In some examples, the request received by the map request reception module 412 may specify the information or layers to be included in the HD map. In some examples, the map layer determination module 414 may determine specific features to include in an HD map rather than layers to be included. After the map layer determination module 414 determines what information to include in an HD map of the geographic area requested by the vehicle 102, the map layer determination module 414 may generate an HD map with the appropriate information included.

The area of interest determination module 416 may determine an area of interest of the driver of the vehicle 102 based on the information received by the map request reception module 412, as disclosed herein. As discussed above, the map request reception module 412 may receive information about what direction the driver of the vehicle 102 is looking with respect to the vehicle 102. As such, the area of interest determination module 416 may determine an area of interest of the driver of the vehicle 102 based on the direction that the driver is looking, the location of the vehicle 102, and a map of the area in which the vehicle 102 is located.

As discussed above, the edge server 104 may maintain a map of a particular geographic area. As such, the edge server 104 may store locations of various attractions, businesses, and other entities. Accordingly, when the map request reception module 412 receives the location of the vehicle 102 and the direction that the driver is looking with respect to the vehicle 102, the area of interest determination module 416 may determine what the driver is looking at based on this information. For example, the area of interest determination module 416 may determine an imaginary straight line extending from the vehicle 102 in the direction that the driver is looking. The area of interest determination module 416 may then determine what this imaginary line would intersect based on the map of the geographic area maintained by the edge server 104. For example, the area of interest determination module 416 may determine that such an imaginary line would intersect with a road sign or a physical building. Thus, the area of interest determination module 416 may determine that the driver of the vehicle 102 is looking at whatever building or entity this imaginary line intersects.

As discussed above, in some examples, the map request reception module 412 may receive information about a direction that the driver of the vehicle 102 is looking at a plurality of time steps. As such, the area of interest determination module 416 may determine what the driver of the vehicle 102 is looking at a plurality of time steps. In embodiments, the area of interest determination module 416 may determine that a particular entity (e.g., a road sign, a business, or other building) is an area of interest of the driver upon determination that the driver looks at the entity for more than a predetermined length of time (e.g., more than 3 seconds). This may prevent the area of interest determination module 416 from determining that a particular entity is an area of interest if the driver merely glances at it. Thus, an area of interest is only determined when the driver looks at the same thing for more than the predetermined length of time. While 3 seconds is given as an example predetermined length of time, it should be understood that any length of time may be used for the predetermined length.

The recommendation module 418 may identify recommendation information for the driver of the vehicle 102 after the area of interest determination module 416 identifies an area of interest of the driver. As discussed above, the area of interest determination module 416 may determine an area of interest of the driver, and in particular, an entity (e.g., a road sign or a business) that the driver is looking at. Accordingly, the recommendation module 418 may determine recommendation information associated with the entity that the driver is looking at. This information may include hours that a business is open, menu items or prices, ratings and reviews, a telephone number or address, and the like. In some examples, the recommendation module 418 may determine recommendation information including a digital coupon or other offer associated with the business that may be transmitted to the vehicle.

In some examples, the edge server 104 may have a relationship with certain businesses to receive digital coupons or other offers that can be transmitted to vehicles (e.g., the edge server 104 may receive a commission for referring vehicles to a particular business). In other examples, the edge server 104 may retrieve information about businesses from publicly available websites.

In some examples, the recommendation module 418 may determine recommendation information based on a time of day or driving statistics associated with the vehicle 102 (e.g., an amount of time that the vehicle 102 has been driven). For example, if it is afternoon, the recommendation module 418 may determine recommendation information associated with lunch options. If it is night time, and the vehicle 102 has been driven for longer than a predetermined amount of time (e.g., more than 4 hours), the recommendation module 418 may determine recommendation information associated with a hotel. As such, the recommendation module 418 may generate recommendations that may be more appropriate for the particular time and circumstances.

As discussed above, in some examples, after the edge server 104 transmits recommendation information to the vehicle 102, the driver of the vehicle may interact with the recommendations (e.g., by accepting or not accepting a particular recommendation), and the vehicle 102 may transmit information about this interaction to the edge server 104. For example, a driver of the vehicle 102 may be able to like or dislike a particular recommendation, and this information may be transmitted to the edge server 104. The recommendation module 418 may receive this feedback and may use this feedback to inform future recommendations. For example, if the driver of the vehicle 102 likes a particular recommendation, the recommendation module 418 may make similar recommendations to that same vehicle 102 in the future. Alternatively, if the driver of the vehicle 102 dislikes a particular recommendation, the recommendation module 418 may refrain from making similar recommendations to the same vehicle 102 in the future. As such, over time, the edge server 104 may learn preferences associated with particular drivers and make future recommendations that are more likely to be appreciated by drivers.

The data request module 420 may request data needed for an HD map and or recommendation information, as disclosed herein. In embodiments, the edge server 104 may maintain a database of information that may be used to generate HD maps and/or recommendations. However, there may be certain information that is not stored on the edge server 104 that may be needed for a particular HD map requested by the vehicle 102. For example, a particular driving application may require information that is not stored on the edge server 104 (e.g., real-time weather data). As such, the data request module 420 may determine whether all of the information needed to generate a requested HD map is stored on the edge server 104, and if not, may transmit a request for any needed information that is not stored on the edge server 104 to a remote computing device (e.g., a weather server). The remote computing device may transmit the information to the edge server 104, which may add the requested information to a generated HD map.

In some examples, if the area of interest determination module 416 identifies a particular business as an area of interest of the driver of the vehicle 102, the data request module 420 may transmit a request for information about that business. For example, the data request module 420 may transmit a request directly to the business for information, or may access a publicly available website of the business to retrieve information about the business. The information received in response to such a request may be used by the recommendation module 418 to determine recommendation information.

The map generation module 421 may generate an HD map to be transmitted to the vehicle 102. In particular, the map generation module 421 may generate an HD map that includes the information determined by the map layer determination module 414.

The data transmission module 422 may transmit information to the vehicle 102. In particular, the data transmission module 422 may transmit the HD map generated by the map generation module 421, and the recommendation determined by the recommendation module 418 to the vehicle 102.

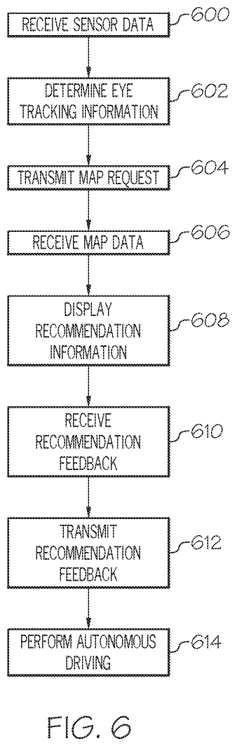

FIG. 6 depicts a flowchart of an example method that may be performed by the vehicle system 200 of the vehicle 102. At step 600, the sensor data reception module 300 receives sensor data from the vehicle sensors 210. The received sensor data may include data from external vehicle sensors (e.g., Lidar, Radar, images) as well as video and/or images of the driver of the vehicle 102 captured by an internal camera.

At step 602, the eye tracking module 302 determines eye tracking information based on data received by the sensor data reception module 300. In particular, the eye tracking module 302 may determine a direction that the driver is looking with respect to the vehicle based on one or more images of the head and eyes of the driver.

At step 604, the map request module 304 transmits a request for an HD map to the edge server 104. In particular, the map request module 304 may transmit a request for an HD map of a particular geographic area, a location of the vehicle 102, driving statistics associated with the vehicle 102 (e.g., how long the vehicle 102 has been driven), a driving application for which the HD map is to be used, and the eye tracking information determined by the eye tracking module 302 (e.g., the direction that the driver of the vehicle 102 is looking with respect to the vehicle at a plurality of time steps).

At step 606, the map reception module 306 receives map data from the edge server 104 in response to the map request transmitted by the map request module 304. In particular, the map reception module 306 may receive an HD map of the requested geographic area as well as recommendation information, as discussed hereinabove.

At step 608, the driver interaction module 308 displays the recommendation information received by the map reception module 306. In particular, the driver interaction module 308 may cause the recommendation information to be displayed on an internal vehicle panel (e.g., an interactive touch screen).

At step 610, the driver interaction module 308 receives recommendation feedback from the driver of the vehicle 102. In particular, the driver may utilize a touch screen that displays the recommendation information to interact with the recommendation information. For example, the driver may like or dislike a recommendation, accept or not accept a digital coupon or other offer associated with a recommendation, or request a service associated with the recommendation (e.g., make a reservation or call a business associated with the information).

At step 612, the driver interaction module 308 transmits the recommendation feedback input by the driver to the edge server 104. Then, at step 614, the vehicle 102 performs one or more autonomous or semi-autonomous driving actions based on the received HD map.

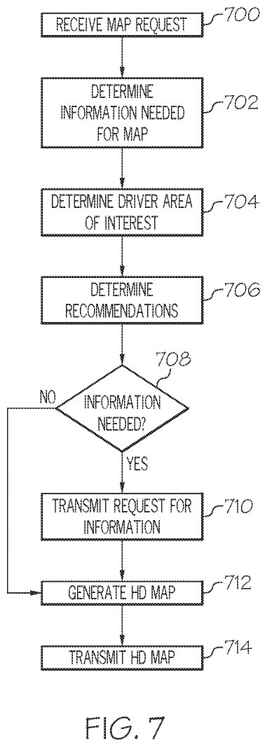

FIG. 7 depicts a flowchart of an example method that may be performed by the edge server 104. At step 700, the map request reception module 412 receives a request for an HD map from the vehicle 102. The request may include a particular geographic area for which the HD map is requested, a location of the vehicle 102, driving statistics associated with the vehicle 102, a driving application for which the HD map is to be used, and eye tracking information associated with the driver of the vehicle 102.

At step 702, the map layer determination module 414 determines what information is needed for the HD map based on the driving application for which the HD map is to be used. In some examples, the map layer determination module 414 determines which layers should be included in the HD map based on the application for which the HD map is to be used.

At step 704, the area of interest determination module 416 determines an area of interest of the driver of the vehicle 102 based on the received eye tracking information. In particular, the area of interest determination module 416 determines what the driver of the vehicle 102 is looking at based on the eye tracking information, the position of the vehicle, and map information associated with the geographic area of the vehicle 102 (e.g., what buildings, signs, and other objects are around the vehicle 102). In some examples, the area of interest determination module 416 determines that a particular object or entity is an area of interest of the driver if it is determined that the driver is looking at the object for more than a threshold amount of time.

At step 706, the recommendation module 418 determines one or more recommendations based on the area of interest of the driver. In particular, the recommendation module 418 may determine one or more recommendations associated with an object that the driver looks at for more than a threshold amount of time. As discussed hereinabove, a recommendation may include information about a business (e.g., open hours, menu items, prices, digital coupons). In some examples, the recommendation module 418 may determine a recommendation based on driving statistics of the vehicle 102 (e.g., how long the vehicle 102 has been driving).

At step 708, the data request module 420 determines whether additional information is needed to generate the requested HD map that is not stored locally on the edge server 104. If additional is needed (Yes at step 708), then at step 710, the data request module 420 transmits a request for the needed information to a remote computing device. If additional information is not needed (No at step 708), then control passes to step 712.

At step 712, the map generation module 421 generates an HD map that includes the information determined by the map layer determination module 414. Then, at step 714, the data transmission module 422 transmits the generated HD map and the recommendation information to the vehicle 102.

It should now be understood that embodiments described herein are directed to edge-assisted personalized high-definition map delivery based on drivers' interests. A vehicle can request an HD map from an edge server for a particular driving application. As such, the vehicle does not need to store the map locally, thereby reducing the data storage required for the vehicle. In addition, the edge server can determine the information needed for the driving application, and can include only the information needed for the driving application in a generated HD map. This may reduce the size of the HD map, and thereby reduce the amount of data to be transmitted from the edge server to the vehicle. Furthermore, the edge server can generate personalized recommendations based on an area of interest of the driver of the vehicle. This may enhance the utility for the driver of using the edge server to generate HD maps.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method comprising:
receiving, from a vehicle, a request for a map of a geographic location, a driving application associated with the request, a position of the vehicle, and a direction that an occupant of the vehicle is looking;
determining information to be included in the map based on the driving application;
generating the map that includes the information;
determining an area of interest of the occupant of the vehicle based on the position of the vehicle and the direction that the occupant of the vehicle is looking;
generating a recommendation based on the area of interest; and
transmitting the generated map and the recommendation to the vehicle.

2. The method of claim 1, further comprising generating the recommendation based at least in part on a time of day.

3. The method of claim 1, further comprising:
receiving driving statistics associated with the vehicle; and
generating the recommendation based at least in part on the driving statistics.

4. The method of claim 3, wherein the driving statistics include how long the vehicle has been driven.

5. The method of claim 1, wherein the area of interest comprises a physical structure that the occupant is looking at.

6. The method of claim 1, further comprising:
receiving the direction at which the occupant is looking at a plurality of time steps; and
determining the area of interest when the occupant looks at a particular location for longer than a predetermined period of time.

7. The method of claim 1, further comprising:
receiving, from the vehicle, feedback about past recommendations; and
generating the recommendation based at least in part on the feedback.

8. The method of claim 1, further comprising determining one or more layers of information to be included in the map.

9. The method of claim 8, wherein the one or more layers of information include static information, dynamic information, and transient information.

10. The method of claim 1, further comprising:
determining whether the information is stored locally; and
upon determination that the information is not stored locally, transmitting a request for the information to a remote computing device.

11. A computing device comprising one or more processors configured to:
receive, from a vehicle, a request for a map of a geographic location, a driving application associated with the request, a position of the vehicle, and a direction that an occupant of the vehicle is looking;
determine information to be included in the map based on the driving application;
generate the map that includes the information;
determine an area of interest of the occupant of the vehicle based on the position of the vehicle and the direction that the occupant of the vehicle is looking;
generate a recommendation based on the area of interest; and
transmit the generated map and the recommendation to the vehicle.

12. The computing device of claim 11, wherein the one or more processors are further configured to:
receive driving statistics associated with the vehicle, the driving statistics including how long the vehicle has been driven; and
generate the recommendation based at least in part on the driving statistics.

13. The computing device of claim 11, wherein the area of interest comprises a physical structure that the occupant is looking at.

14. The computing device of claim 11, wherein the one or more processors are further configured to:
receive the direction at which the occupant is looking at a plurality of time steps; and
determine the area of interest when the occupant looks at a particular location for longer than a predetermined period of time.

15. The computing device of claim 11, wherein the one or more processors are further configured to:
receive, from the vehicle, feedback about past recommendations; and
generate the recommendation based at least in part on the feedback.

16. The computing device of claim 11, wherein the one or more processors are further configured to determine one or more layers of information to be included in the map, the layers including static information, dynamic information, and transient information.

17. The computing device of claim 11, wherein the one or more processors are further configured to:
determine whether first information is stored locally; and
upon determination that first information is not stored locally, transmit a request for the information to a remote computing device.

18. A system comprising a vehicle and an edge server, wherein:
the vehicle transmits, to the edge server, a request for a map of a geographic location, a driving application associated with the request, a position of the vehicle, and a direction that an occupant of the vehicle is looking; and
the edge server comprising one or more processors configured to:
receive the request from the vehicle;
determine information to be included in the map based on the driving application;
generate the map that includes the information;
determine an area of interest of the occupant of the vehicle based on the position of the vehicle and the direction that the occupant of the vehicle is looking;
generate a recommendation based on the area of interest; and
transmit the generated map and the recommendation to the vehicle.

19. The system of claim 18, wherein the vehicle is further configured to:
receive the map from the edge server; and
autonomously perform one or more driving operations based on the map.

20. The system of claim 18, wherein the vehicle is further configured to:
receive the recommendation from the edge server;
display the recommendation to the occupant of the vehicle;
receive feedback about the recommendation; and
transmit the feedback to the edge server.
